(19) United States
(12) Patent Application Publication
(10) Pub. No.: US 2024/0081364 A1
(43) Pub. Date: Mar. 14, 2024

(54) Method and Device for Demoulding a Confectionery Item from a Casting Mould

(71) Applicant: Winkler and Dünnebier Süßwarenmaschinen GmbH, Rengsdorf (DE)

(72) Inventors: Rainer Runkel, Rengsdorf (DE); Christian Freund, Kurtscheid (DE); Holger Brack, Rümmelsheim (DE); Sebastian Dommasch, Kruft (DE); Artur Ticholis, Rengsdorf (DE)

(21) Appl. No.: 18/275,504

(22) PCT Filed: Jan. 31, 2022
(86) PCT No.: PCT/EP2022/052211

§ 371 Date: Aug. 2, 2023

(30) Foreign Application Priority Data
Feb. 2, 2021 (DE) 10 2021 102 326.2

(51) Int. Cl. A23G 3/02; A23G 3/34; A23G 7/00; B25J 15/06

(52) U.S. Cl. CPC A23G 3/0284; A23G 3/0038; A23G 7/0037; A23G 7/0087; B25J 15/0616

(57) ABSTRACT

The invention relates to a method and a device for demolding at least one confectionary item (2), which is to be demolded from a cavity (4) of a casting mold (3) upside down by means of a gripping arrangement (5), wherein the gripping arrangement (5) has at least one suction element (6) with which the substantially flat base (32) of the confectionary item, which base is facing upwards, is suctioned, wherein the confectionary item (2), where it is transferred upside down by a switching off of the negative pressure, wherein before or after the suction element (6) has suctioned the base (32) of the confectionery item (2), a loosening movement is generated which introduces alternating forces into the confectionery item (2) which generate deformations in the confectionery item (2) which act right up to the outer border layer of said confectionery item and reduce the adhesive force of said confectionery item at the contact surface of the cavity (4) and at least partially release the adhesive force, and wherein the confectionery item (2) is then completely removed from the cavity (4) by the suction element (6).

The invention relates to a method and a device for demolding at least one confectionery item from a cavity of a casting mold using a gripping arrangement with at least one suction element. The device preferably comprises at least one casting mold.

A generic method and a device for demolding at least one confectionery item are known from U.S. Pat. No. 6,165,531 A. This state of the art relates to the production of a fat-based confectionery item, for example chocolate. For this, the chocolate is cast into a cavity of a casting mold, namely into a casting mold the material of which is to have a low surface energy, in order to make an easier demolding of the confectionery item possible. Silicone or polytetrafluoroethylene are proposed as examples of the material of the casting mold. The easier demolding is to improve the compatibility of casting and “pick-and-place” technology for taking the molded product out of the cavities. This state of the art uses the term pick-and-place devices to describe robotic systems which lift molded products by means of suction and move them onto a surface, e.g., a conveyor belt, where they are deposited for further processing by terminating the suction.

The known method of U.S. Pat. No. 6,165,531 A benefits from the effect, generally known in this field, of a decrease in volume of chocolate when it solidifies. The effect is based on the property of cocoa butter to contract as a result of its crystallization when the cocoa butter solidifies from the molten state. The contraction of the cocoa butter results in a decrease in volume of the entire confectionery item produced with it. The decrease in volume promotes the demolding of the confectionery item from the cavity of the casting mold. It is therefore a generally known procedure to influence the degree of contraction of the confectionery item in order to optimize the demolding. In the case of a confectionery item made of chocolate, the influencing of the contraction happens, for example, due to a correspondingly controlled tempering of the chocolate to be cast as well as a subsequent favorably controlled cooling of the confectionery item. In the case of a filled confectionery item, an under-tempering can, for example, result in a stronger contraction and in a better demolding (4^{th} edition 2009, Beckett, Industrial Chocolate Manufacture and Use).

There are other confectionery items made of mixtures which are not subject to such a large decrease in volume due to contraction. These include soft confectionery items containing sugar and/or starch. As a rule, they moreover have a certain stickiness. Because of forces of adhesion to the contact surface of the cavity, the outer boundary layer of the confectionery item remains sticking to it. Even when the contact surface of the cavity consists of a material which has a low surface energy, certain forces of adhesion are preserved, which increase the forces required for demolding and make demolding more difficult.

The object of the invention is to propose a method and a device for demolding a low-contraction sticky confectionery item from a casting mold, with the result that the confectionery item can be taken out using a gripping arrangement with a suction element despite possible forces of adhesion that act between its boundary layer and the contact surface of the cavity of the casting mold.

The object is achieved according to the invention by a method according to claim 1, as well as by a device according to claim 7. Advantageous embodiments follow in each case from the dependent claims.

The suction element of the gripping arrangement is expediently positioned against the confectionery item substantially orthogonal to the plane of the casting mold and the bottom of the confectionery item is sucked in against the suction element by means of negative pressure.

The inventor has discovered that, if such a confectionery item, the boundary layer of which sticks firmly to the contact surface of the cavity, is moved out perpendicularly, it can happen that it remains sticking around the circumference and above all at the upper edge of the contact surface when the suction element pulls the confectionery item out of the cavity, while a detachment of the boundary layer of the confectionery item begins in the lower region, i.e., at the base of the cavity. If that happens, a hollow space forms at the base of the cavity, but a pressure equalization cannot immediately take place. This effect is more strongly pronounced in the case of softer confectioneries, which deform when moved out of the cavity and can be easily sucked in by the suction element such that the sucked-in surface bulges slightly into the suction element. A negative pressure therefore forms in the hollow space, which increases the forces for a continuing movement of the confectionery item out of the cavity and hampers the demolding.

On the other hand, it can happen that during the movement out a tapering of the confectionery item takes place in the region of the upper edge of the contact surface of the cavity and the detachment of the confectionery item begins there at the top and not at the base of the cavity. Independently of the point at which the detachment of the confectionery item begins, in each case the forces which are required for the demolding are increased due to the forces of adhesion of the confectionery item to the contact surface of the cavity and due to the formation of a hollow space. The speed of the movement of the suction element away from the cavity is important. Too quick a movement away can have the result that the confectionery item remains adhering in the cavity and cannot be demolded.

In order to promote a reliable detachment and to counteract damage to the confectionery item, it is expedient if the movement of taking the confectionery item out is carried out at a suitable and adapted speed. The inventor surprisingly discovered that this, combined with an additional detachment movement, makes it possible to be able to take confectionery items sticking in a cavity reliably out of the cavity without damaging them.

It is expedient if, for the detachment movement, on the one hand the suction element sucks the bottom of the confectionery item in and holds it firmly and on the other hand a relative movement between the suction element and the casting mold is generated, with the result that the force of adhesion of the outer boundary layer of the confectionery item is reduced at least partially on the contact surface of the cavity by means of the relative movement.

A further benefit results if the detachment movement is provided as an oscillating detachment movement or a circulating detachment movement, and if the detachment movement is performed by the casting mold and/or the suction element. The circulating detachment movement can be effected, for example, on a circular or elliptical movement path.

In a simple manner, the detachment movement is performed in the plane of the casting mold or in a plane parallel thereto.

According to an embodiment, for the purpose of generating a detachment movement, the casting mold is set in a shaking movement/vibration, namely before or after the suction element has sucked in the bottom of the confectionery item. The terms vibration and shake, shaking or shaking movement are synonymous within the meaning of the invention. Such a shaking movement/vibration is preferably transmitted into the casting mold such that it moves in the plane of the casting mold. Through the movement of the confectionery item out of the cavity and through the relative movement, an interaction between the contact surface of the cavity and the outer boundary layer of the confectionery item occurs above all in the upper region of the cavity. Normal forces occur, which result in the peeling of the confectionery item off the contact surface, whereby the demolding of the confectionery item is promoted. The normal force is a resultant of a surface force distributed over the entire cross section of the cavity. The adhesion thereof to the contact surface of the cavity can be at least partially released. The detachment succeeds to such an extent that the remaining force of adhesion between the confectionery item and the cavity is reduced in such a way that the suction force of the suction element on the confectionery item is sufficiently strong that the suction element can pull the confectionery item out of the cavity. The forces introduced deform the confectionery item in such a way that the force of adhesion to the contact surface of the cavity at best breaks down entirely or at least reduces. The more the confectionery item detaches from the contact surface of the cavity, the easier its demolding is.

This type of detachment movement can be transmitted into the casting mold, for example, with a vibration generator.

Depending on the design, vibration generators can generate a vibration or shaking with different quality, in particular in different movement paths. Fluidically drivable piston vibrators, which generate a vibration on a rectilinear movement path, or fluidically drivable rotating turbine or motor vibrators, the rotating component of which carries an unbalance are known as vibration generators.

The inertia of the unbalance mass transmits a vibration to the turbine or motor housing. The vibration generator can be installed such that it acts on the casting mold directly, or indirectly by transmitting its vibration into a carrier element, which for its part carries the casting mold and sets it in motion.

Alternatively, the vibration generator can also be electrically drivable, as an electrical linear drive or as an electrical unbalance motor.

The detachment movement can be performed exclusively or additionally with a movement component in a direction orthogonal to the plane of the casting mold. A vibration generator can for this purpose be mounted in a corresponding alignment in order to perform a detachment movement in a horizontal plane, i.e., parallel to the plane of the casting mold, or in a vertical plane or in any other suitable angular position relative to the plane of the casting mold.

Furthermore, the detachment movement can be generated with a transport system according to DE 10 2019 101 290 B3. This patent imparts a transport system which can transport a casting mold through a confectionery machine and in addition generate an auxiliary movement which is required in the production process. The possible auxiliary movements include a shaking movement, with which, for example, confectionery mixture poured into the casting mold can be uniformly distributed. For the present invention, the generation of the shaking movement according to DE 10 2019 101 290 B3, which is possible with the transport system thereof, is incorporated by reference. The auxiliary movement is optimized and adapted for the purpose of the present invention such that an effective detachment of a confectionery item adhering in the cavity is achieved. The detachment movement generated in this way can take place parallel to the transport movement of the casting mold (X direction) or sideways relative to the transport movement in the same plane of the casting mold (Y direction) or alternatively in a direction perpendicular to the transport plane of the casting mold (vertically) (Z direction). A mixing movement horizontally/vertically, which has portions in the X and/or Y direction plus Z direction, is also possible.

Through a combination of movement sequences between the casting mold and the gripping arrangement, an efficient and gentle demolding of a soft confectionery item from the cavity of a hard casting mold is possible.

Due to the proposed detachment movement, a first gap can form which produces a connection between the hollow space forming at the base of the cavity during the demolding and the surrounding atmosphere. A pressure equalization in the hollow space is thus made possible and the forces required for the further demolding are reduced.

When being taken out, the confectionery item may still adhere in places. However, the suction force of the suction element is sufficient in order to be able to pull strongly enough on the confectionery item, with the result that the confectionery item lengthens and contracts. Its diameter is reduced. The speed of the pulling out can be carried out slowly in a suitable manner. Together with the supporting detachment movement between the casting mold and the suction element, above all at the start of the detachment process, normal forces, which bring about a detachment of the confectionery item from the contact surface by peeling, occur in the upper region of the boundary layer of the confectionery item and the contact surface of the cavity. Above all, soft confectionery items promote and strengthen the effect of normal forces during the detachment movement. The type of load on the boundary layer of the confectionery item is approximately comparable to the stress distribution in a glue joint which is subjected to a peeling load.

The detachment movement and the movement orthogonal to the casting mold necessary for taking the confectionery item out can be superimposed in order to obtain advantageous gentle demolding results without damage to the confectionery item.

It is advantageous if the suction element sucks the confectionery item in at the same time when the detachment movement is also being transmitted into the casting mold. However, the confectionery item is preferably sucked in against the suction element first, with the result that it is already held firmly thereto when the detachment movement is performed.

In a further alternative, the detachment movement is started first, and only then is the confectionery item sucked in and held firmly against the suction element. This procedure is advantageous, e.g., for confectionery items with uneven surfaces because partial detachment of the confectionery item from the contact surface of the cavity of the casting mold already takes place due to the previous detachment movement. This makes a better positioning of the suction elements against the confectionery item possible. In the case of an uneven surface of a confectionery item, it can happen that the suction element cannot be applied sufficiently tightly, with the result that initially a sufficient vacuum cannot form. Due to a relative movement starting or already taking place, the suction element then moves over the uneven surface to a position which makes a sufficient vacuum possible.

A method for transferring at least one confectionery item from a casting mold towards a depositing position is regarded as an original invention. According to this method, the confectionery item is demolded upside down from a cavity of the casting mold and then turned to an upright position, with the result that it is transferred to the depositing position in the upright position, wherein a first gripping arrangement takes the confectionery item out of the cavity upside down by means of a downwardly directed suction element and transfers it to a second gripping arrangement in an intermediate position in the upside down position, wherein the second gripping arrangement has a rotatably arranged suction element, which accepts the confectionery item in the upside down position, and wherein the second gripping arrangement then turns the confectionery item to the upright position and transfers it to the depositing position. This procedure has the advantage that the turning of the confectionery item from the upside down position to the upright position on the one hand and the path from the intermediate position into the depositing position can be performed at the same time in one movement step. Moreover, in this way, the still relatively sticky underside of the confectionery item, which adheres to a tray or a belt, cannot stick to other confectionery items.

For the method for transferring the confectionery item from the casting mold towards the depositing position, a development is preferably provided according to which the confectionery item is demolded from the cavity of the casting mold according to the method, proposed at the beginning, of one of claims 1 to 5 and taken out of the cavity.

Furthermore, to achieve the above object, a device is proposed for demolding at least one confectionery item from a cavity of a casting mold, preferably comprising at least one casting mold, as well as comprising a gripping arrangement with at least one suction element, wherein a means for performing a detachment movement is provided for a confectionery item the outer boundary layer of which adheres in a sticking manner in the cavity of the casting mold, wherein alternating forces, such as tensile forces, compressive forces and shearing forces, can be introduced into the confectionery item via the means for the detachment movement, whereby deformations, such as expansions and contractions, can be generated on its boundary layer, with the result that the force of adhesion of the confectionery item in the cavity is reduced to such an extent that the coupling suction forces of the suction element are sufficient in order to take the confectionery item out of the cavity by means of the suction element.

A suitable means for performing a detachment movement is set up to introduce a shaking/vibration into the casting mold. For this purpose, the means can be provided with a simple tapping element which can tap against the casting mold at a suitable frequency and sets it in a shaking movement.

Alternatively, the means for performing the detachment movement can be connected to a casting mold receiver as a carrier element, which carries the casting mold, for example a vibration generator, which is coupled to the casting mold receiver. The casting mold carried on by the casting mold receiver is then indirectly set in vibration. The vibration generator can generate the detachment movement of the casting mold receiver pneumatically or hydraulically, or electrically.

The casting mold receiver expediently has several stop elements which limit the movement range for the vibration of the casting mold to a suitable range. The dimensions of the range are such that a vibration with the desired amplitude is made possible in all required directions. The casting mold receiver can be formed as an oscillating frame with stop elements. A frame-shaped structure that is as light as possible is expedient in order to reduce the mass to be vibrated which has to be excited.

Instead of limiting the movement for the vibration of the casting mold by means of stop elements, clamping elements can be provided, with which the casting mold can be fixed to the casting mold receiver. The clamping elements can connect the casting mold to the casting mold receiver in a friction-locking manner, for example via a spring. Alternatively, the clamping force can be generated with electrically, hydraulically or pneumatically drivable clamping elements. In a simple manner, the clamping elements are designed as clamping jaws. The clamping elements fix the casting mold preferably at two points, preferably on the edge of the casting mold.

Another alternative for fixing the casting mold to the casting mold receiver can be set up to produce a positive-locking connection.

The casting mold is preferably a hard, dimensionally stable casting mold made of a metal or made of a solid plastic.

A polycarbonate or a copolymer containing polycarbonate units or a mixture of polycarbonate with other polymers is preferably provided as plastic. Molds made of polyethylene, polystyrene and polyethylene terephthalate, where appropriate modified by comonomers or blending, also fulfil the purpose.

The means for performing the detachment movement is expediently set up to generate an oscillating detachment movement. The oscillation can be a translational back and forth movement or a circulating movement in which a circulating mechanical oscillation is generated by means of an unbalance.

The relative movement of the casting mold, whether it is linear or circulating, can be combined with a vertical movement of the movement unit for the gripping arrangement, which is provided with the suction element, in order to take the confectionery item out of the cavity.

A further embodiment is formed such that the casting mold remains stationary and a movement unit for the suction element is provided instead in order to impress a detachment movement on it, e.g., to set it in a vibration. The suction element thus not only sucks the confectionery item in by means of the negative pressure provided and holds it firmly thereon, but in this embodiment also transmits the vibration into the bottom of the upside down confectionery item. Forces which cause expansions and contractions inside the confectionery item in the upper region of the cavity are thereby introduced into the bottom of the upside down confectionery item. These forces initiate a detachment of the confectionery item above all in the upper region of the cavity of the casting mold.

The present invention is intended for the processing of confectionery mixtures which, unlike chocolate-type preparations, do not shrink substantially during cooling and moreover adhere in a relatively firmly sticking manner to the cavity of the casting mold. In addition, the casting mold consists of a hard, not rubbery-elastic material. With these conditions it is proposed that the contact surface of the cavity of the casting mold is provided with a release agent, such as is proposed in DE 10 2007 031 747 A1. Its teaching on the wetting of the contact surface of the cavity with a release agent is incorporated here by reference. The release agent can ensure that the confectionery item adheres less strongly to a contact surface of the cavity and the confectionery item can be more easily demolded. However, the separating effect is dependent on how successful the wetting of the cavity is. In the case of a wetting by means of spray nozzles, it has been shown that in the upper region of the cavity less release agent tends to be able to separate effectively, because it can run down beforehand and collects on the base of the cavity. Sticking forces of adhesion of the confectionery item in the upper region of the cavity of the casting mold therefore sometimes occur even though a release agent was used.

If regions of the boundary layer of the confectionery item remain sticking in the cavity despite the use of a release agent, this mainly happens in very steep regions of the contact surface of the cavity, which are normally located in the upper region of the cavity. It is then helpful to generate a detachment movement which can promote a detachment of the confectionery item from the contact surface of the cavity particularly in the upper region thereof. As soon as a detachment begins at one point in the upper region of the cavity, it can continue more easily around the circumference. The detachment is supported by the suction element when it pulls on the confectionery item in order to take it out of the cavity. Precisely at the points at which a wetting with release agent is difficult, the detachment movement can make a damage-free demolding of the confectionery item possible.

It is beneficial if a movement unit for the gripping arrangement is provided, and if the gripping arrangement is movable by means of the movement unit at least in two movement directions, namely preferably translationally in a sideways direction back and forth as well as in a vertical direction up and down.

Beneficially, the gripping arrangement can have an air chamber and at least two suction elements connected to the air chamber can be provided, wherein each suction element is expediently provided with a flow resistance.

In a simple manner, the flow resistance is formed as a baffle in the suction element, for example in the form of a small hole. With the common air chamber of the gripping arrangement, it is possible to apply a partial vacuum to all suction elements 6 together at the same time.

It can happen that no confectionery item is present for one of the suction elements, as a result of which outside air is sucked in by this suction element. Due to the built-in flow resistance, the volumetric flow of the sucked-in outside air is minimized. The device can therefore also be operated when a confectionery item is not present for all suction elements, as long as a sufficient partial vacuum still remains in order to hold the confectionery items present sufficiently firmly for the purpose of demolding from a casting mold.

Likewise regarded as an invention is a device for transferring at least one confectionery item from a starting position, in which the confectionery item adheres in a cavity of a casting mold and can be demolded from the cavity, towards a depositing position, preferably comprising at least one casting mold with at least one cavity, as well as comprising a first gripping arrangement with at least one downwardly directed suction element and a movement unit for moving the confectionery item from the starting position towards an intermediate position, wherein a second gripping arrangement is provided which has an axis of rotation and at least one suction element, which is arranged movable about the axis of rotation, and wherein at least two functional rotational positions are defined for the second gripping arrangement, a receiving position with upwardly directed suction element and a depositing position with downwardly directed suction element.

For the above-named device, which is provided for transferring the confectionery item from the starting position, in which it adheres in the cavity of the casting mold, towards the depositing position, it is in addition proposed to preferably provide a device according to one of claims 7 to 10 for being able to demold the confectionery item from the cavity.

For the device for transferring the confectionery item from the starting position towards the depositing position, it is expediently provided that the intermediate position of the first gripping arrangement coincides with the receiving position of the second gripping arrangement.

Furthermore, the device for transferring the confectionery item towards the depositing position can be improved by arranging and setting up the axis of rotation of the second gripping arrangement such that, by means of a rotation from the receiving position into the depositing position, the confectionery item is turned from the upside down position to the upright position and at the same time can be transported from the receiving position to the depositing position.

Embodiment examples of the invention are represented by way of example in a drawing and described in detail with reference to several figures below. There are shown in:

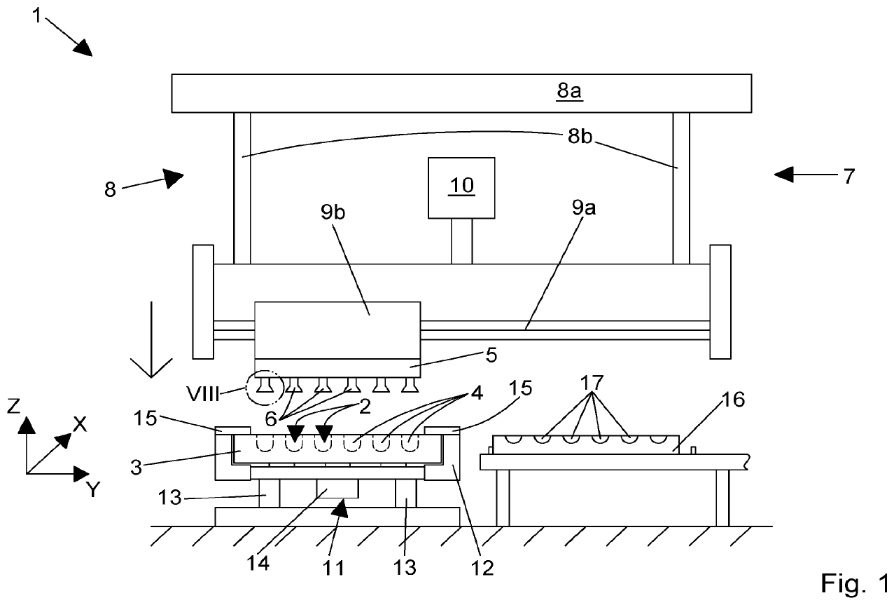

FIG. 1: an embodiment example of a device for demolding adhering confectionery items from the cavities of a casting mold,

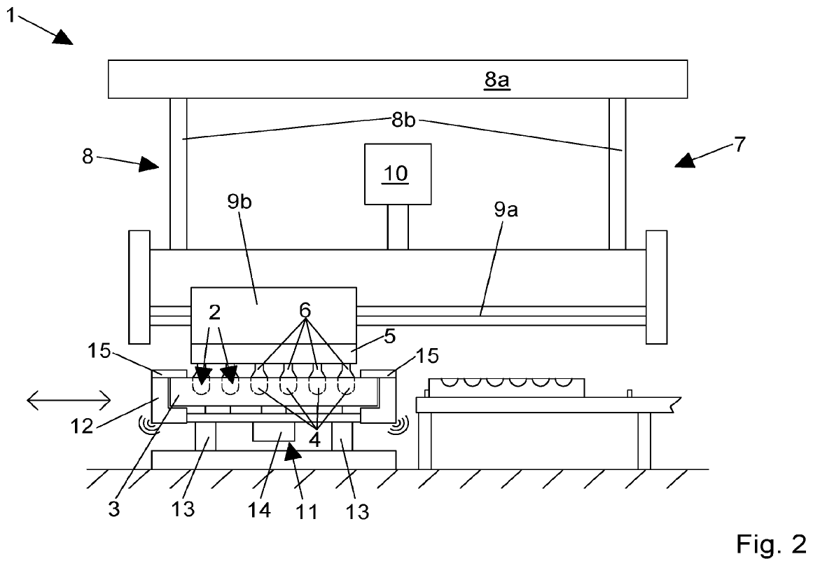

FIG. 2: the embodiment example according to FIG. 1 during the step of coupling the confectionery item to a gripping arrangement and introducing a detachment movement into the casting mold,

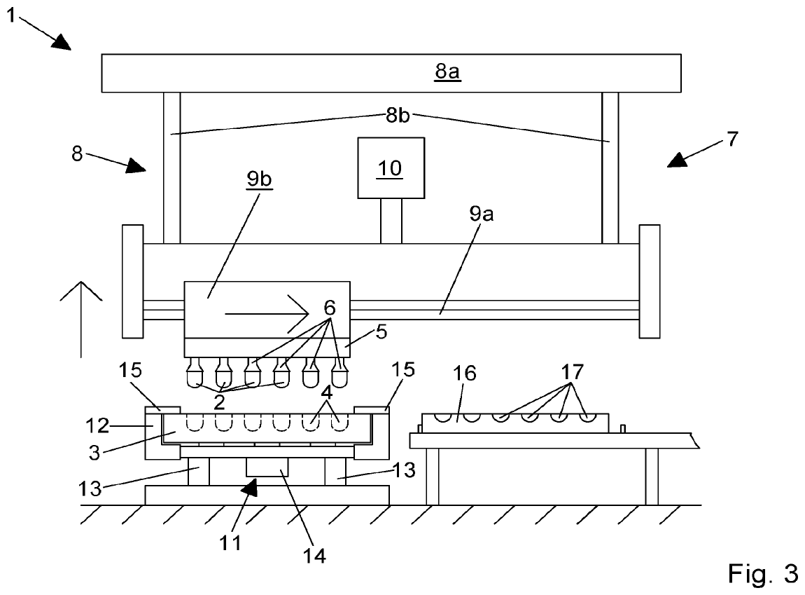

FIG. 3: the embodiment example according to FIG. 1 while the coupled confectionery item is being taken out of the casting mold,

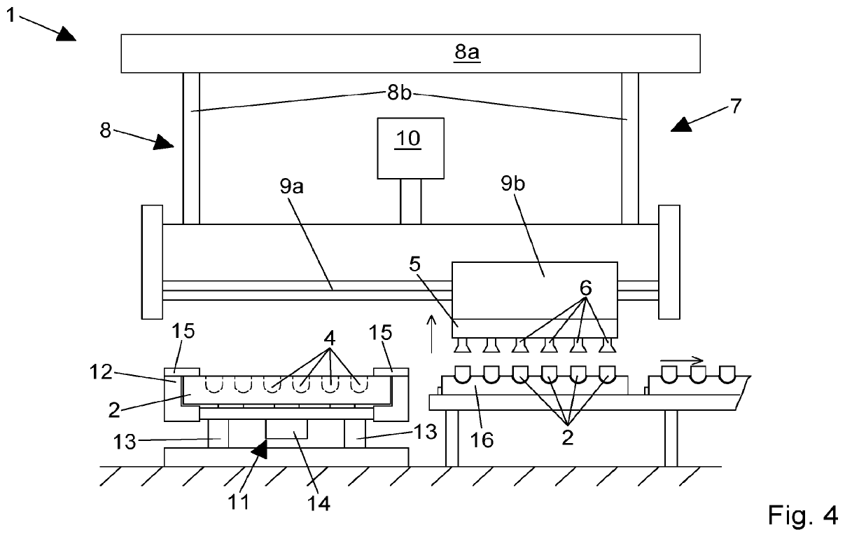

FIG. 4: the embodiment example according to FIG. 1, wherein the gripping arrangement has been moved laterally to a transfer point and has transferred the confectionery items upside down,

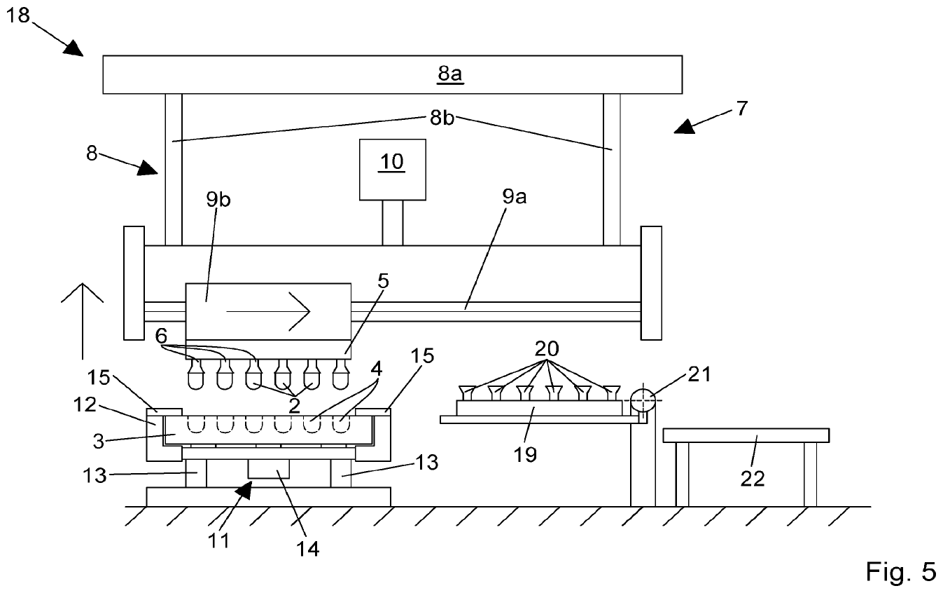

FIG. 5: an embodiment example of a device for transferring confectionery items from a starting position in a cavity of a casting mold towards a depositing position, comprising a first and a second gripping arrangement,

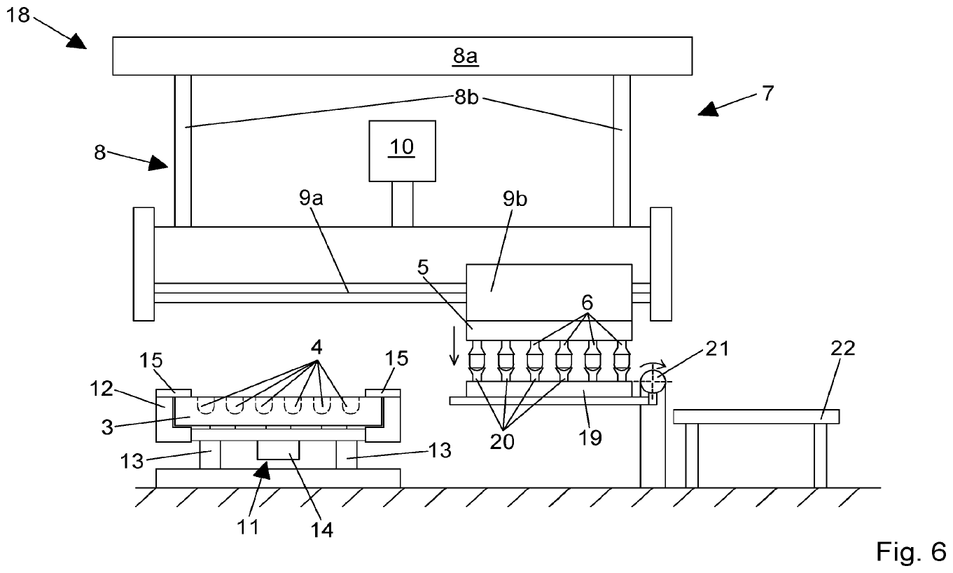

FIG. 6: the embodiment example according to FIG. 5 during the transfer of the confectionery items upside down in an intermediate position to the second gripping arrangement,

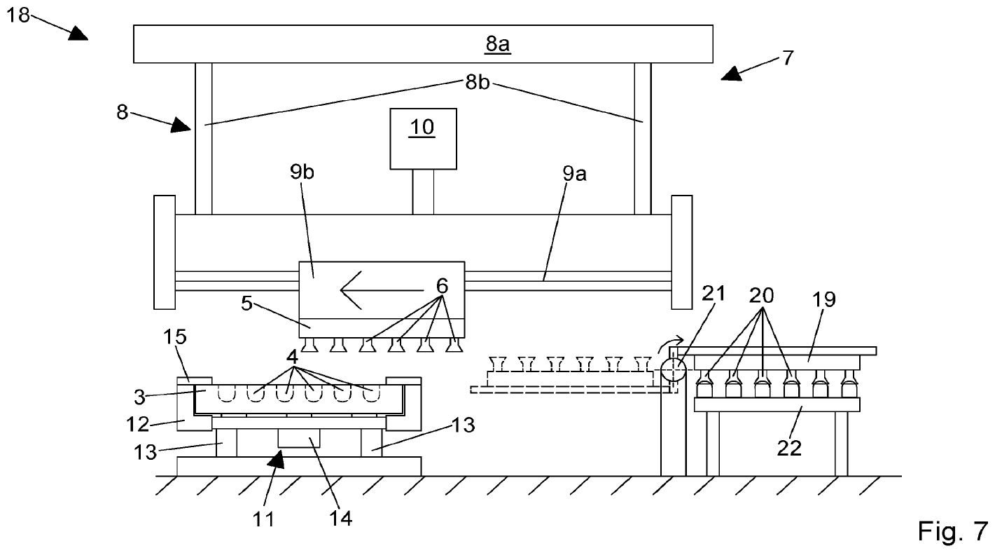

FIG. 7: the embodiment example according to FIG. 5 after a movement of the second gripping arrangement from a receiving position into a depositing position with downwardly directed suction element,

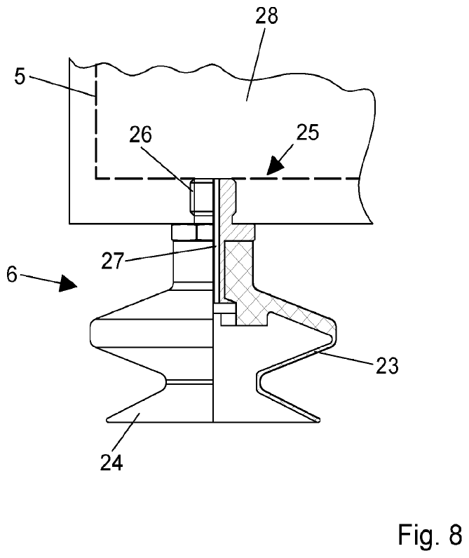

FIG. 8: an enlarged representation of the section VIII with suction element in FIG. 1,

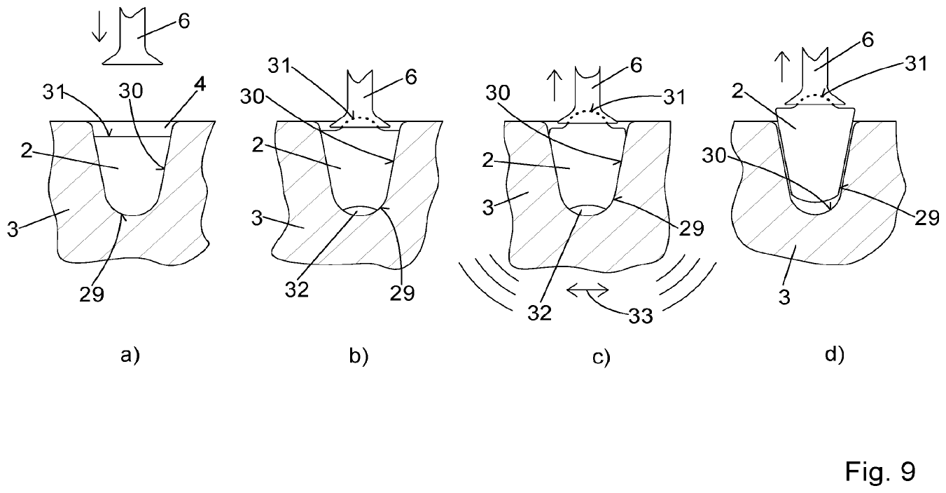

FIG. 9: an enlarged view of the demolding process.

FIGS. 1 to 4 show schematic representations of an embodiment example of the device 1 according to the invention, which is provided for demolding a confectionery item 2 from a casting mold 3, which confectionery item 2 has sticky adhering properties. It is possible with this device to execute the method according to the invention, with which the force of adhesion of the confectionery item 2 is decreased, with the result that the latter can be taken out of a cavity 4 of the casting mold 3.

The casting mold 3 can be viewed as part of the device 1. In the example, it has six cavities 4, which are arranged in a row. The device 1 is in addition provided with a gripping arrangement 5, which has suction elements 6. Matching the number and position of the cavities 4, six suction elements 6 are provided on the gripping arrangement 5. Furthermore, a movement mechanism 7 for the gripping arrangement 5 is provided, with which the latter can be moved up and down (Z direction) as well as sideways (Y direction).

The movement mechanism 7 has a lifting unit 8 for being able to move the gripping arrangement 5 up and down (Z direction) and the movement mechanism 7 is provided with a sideways unit 9 for being able to move the gripping arrangement sideways in the Y direction. The lifting unit 8 comprises a carrying element 8a, which can be moved up and down by means of a vertical drive and a vertical guide unit 8b. The sideways unit 9 comprises a horizontal drive and a horizontally arranged linear guide 9a with a carriage element 9b, on which the gripping arrangement is arranged.

The casting mold 3 can in addition be transported away in a transport direction (X direction) by the device 1 according to the invention. The transport direction of the casting mold 3 lies in its plane as well as at right angles to the sideways movability of the gripping arrangement 5 (Y direction). The three-dimensional coordinates X, Y, Z are represented symbolically in FIG. 1, wherein the X direction is oriented perpendicular relative to the (only) two-dimensional representation of FIG. 1.

According to FIG. 1, the device furthermore comprises a vacuum mechanism 10 for generating a partial vacuum. By partial vacuum is meant a lower pressure (negative pressure) compared with the atmospheric air pressure of the environment in which the device is located. The vacuum mechanism 10 is connected to the suction elements 6 of the gripping arrangement 5. Via a control mechanism (not represented) and a corresponding tubing, the partial vacuum applied to the suction elements 6 can be switched on and off for this purpose. Either the control mechanism, or the tubing, is set up or programmed such that the suction effect can be switched on and off for all suction elements together or each individual suction element can be switched on and off individually.

The device according to FIG. 1 additionally has a means 11 for performing a detachment movement. With the means 11, alternating forces can be introduced into the confectionery item, which reach up to its boundary layer and generate deformations in the material of the confectionery item, in particular expansions and contractions. Due to these deformations, the force of adhesion of the confectionery item in the cavity of the casting mold can be reduced. The force of adhesion can be reduced to such an extent that the suction forces of the suction element are sufficient in order to take the confectionery item out of the cavity by means of the suction element and with the aid of the lifting unit 8, because the lifting unit 8 of the movement mechanism 7 moves the gripping arrangement 5 upwards. Should a residual force of adhesion still be present, this is released during the upwards movement of the gripping arrangement.

In the present example, the means 11 for performing the detachment movement comprises a casting mold receiver 12, which is provided with swing bearings 13. A vibration generator 14, which can set the casting mold receiver 12 in a vibration or shaking movement, is arranged on the casting mold receiver 12.

In order to be able to transmit the vibration efficiently into the casting mold 3, the casting mold receiver 12 is formed in the manner of a frame and has upper bar elements 15.

In the present example, it is provided that the bar elements 15 can exert a clamping force on the top of the casting mold in order to fix it to the casting mold receiver 12 in a clamping manner. Thus, a friction-locking connection between the casting mold 3 and the casting mold receiver 12 is generated, with the result that the casting mold 3 vibrates synchronously with the casting mold receiver 12.

Alternatively, the casting mold receiver 12 formed in the manner of a frame, including the upper bar elements 15, can be set up such that a certain movement range remains for the casting mold, with the result that the casting mold can vibrate within the movement range independently of the casting mold receiver 12.

Laterally next to the casting mold receiver 12, a depositing element 16 is provided, which has six receiver elements 17. The receiver elements 17 are set up to receive the confectionery items 2 upside down. In this embodiment example, the receiver element 17 is a part of a product packaging.

FIG. 2 shows the device according to FIG. 1 while the method step of vibrating the casting mold receiver 12 is under way. Moreover, the method step of sucking the confectionery items in by the suction elements 6 is under way.

The lifting unit 8 has moved the gripping arrangement 5 downwards, which also includes the sideways unit 9 in this example. In this way, the suction elements 6 come into contact with the bottoms of the confectionery items. The partial vacuum provided by the vacuum mechanism is applied to the suction elements 6, and the bottom of each of the confectionery items 2 is held firmly in this way, while at the same time the vibration of the casting mold receiver 12 is under way or is then got under way.

The vibration is transmitted into the casting mold 3 from the casting mold receiver 12. From the casting mold 3, the vibration passes into the confectionery item. At the boundary layer of the confectionery item 2 adhering in a sticking manner, the vibration acts as a detachment movement, because the tensile, compressive forces and shearing forces introduced into the confectionery item cause expansions and contractions in the material of the confectionery item, which act up to its outer boundary layer and there reduce the force of adhesion to the contact surface of the cavity 4.

Next, it is shown in FIG. 3 how the confectionery item 2 is taken out of the cavities 4 of the casting mold 3. The vibration generator 14 has been stopped and the gripping arrangement 5 has been moved upwards by means of the lifting unit 8 of the movement mechanism 7, with the result that the confectionery items 2 are finally demolded.

Then, as represented in FIG. 4, the gripping arrangement 5 is moved away from above the casting mold receiver towards a position above the depositing element 17 by means of the sideways unit 9. FIG. 4 already shows the state after the lifting unit has been lowered in this position in order to deposit the confectionery items 2. For this, the partial vacuum on the suction elements has been switched off and the confectionery items 2 have passed into the receiver elements 17. A jet of compressed air can be used to transfer the confectionery item 2 from the suction elements 6. For this, the vacuum applied to the suction element 6 is switched off and instead the jet of compressed air is triggered. The confectionery item can in this way be ejected from the suction element 6. Moreover, the gripping arrangement 5 has already been moved upwards again together with the sideways unit 9. The suction elements 6 are “empty”. From this position, the gripping arrangement 5 is moved back into its position above the casting mold receiver 12, as shown in FIG. 1, by means of the sideways unit 9, and the process can be repeated with the following casting mold 3.

FIG. 5 represents a device 18 for transferring at least one confectionery item 2, which is transferred from a cavity 4 of a casting mold 3 in two steps towards a depositing position (transfer device). For this purpose, the transfer device 18 comprises a first and a second gripping arrangement.

The transfer device 18 is in large parts identical to the device according to FIGS. 1 to 4, with the result that identical reference numbers are adopted for identical features. In other words, the transfer device 18 likewise comprises a movement mechanism 7 with a lifting unit 8 and a sideways unit 9. A device for demolding is likewise integrated, which comprises a vacuum mechanism 10 for the suction elements of the first gripping arrangement, as well as a means for generating a detachment movement, a casting mold receiver 12 on swing bearings 13 as well as a vibration generator 14.

The transfer device 18 differs from the device 1 of FIGS. 1 to 4 only in that an already mentioned second gripping arrangement 19 is provided. The second gripping arrangement 19 replaces the depositing element 16 provided in FIGS. 1 to 4. The first gripping arrangement according to FIG. 5 on the other hand is identical to the gripping arrangement according to FIGS. 1 to 4.

In the present example, the casting mold 3 is again provided with six cavities 4. The position of the casting mold 3, or respectively the cavities 4 thereof, as shown in FIG., form a starting position. From this starting position, the transfer of the confectionery items 2 by means of the first gripping arrangement 5 begins.

The method stage shown in FIG. 5 corresponds to the stage in FIG. 3, because the first gripping arrangement 5 has already demolded the confectionery items, as in FIG. 3, and lifted them out of the cavities of the casting mold 3. The vibration generator 14 has been stopped and the first gripping arrangement 5 has been moved upwards by means of the lifting unit 8 of the movement mechanism 7, with the result that the confectionery items 2 are demolded.

In FIG. 5, the second gripping arrangement 19 is in an intermediate position, in which the confectionery items 2 are accepted upside down. For this, the second gripping arrangement 19 has six suction elements 20, which are directed upwards in the intermediate position shown. The suction elements 20 are constituted such that they can effectively suck the upside down confectionery items 2 in and hold them firmly on their downwardly directed top. The suction elements 20 of the second gripping arrangement 19 are connected to the vacuum mechanism 10 and, via a control mechanism with corresponding tubing (not represented), a partial vacuum can be applied to the suction elements 20 and can be switched on and off for this purpose. The control mechanism, or the tubing, is set up or programmed such that the suction effect can be switched on and off for all suction elements 20 together or each individual suction element 20 can be switched on and off individually.

FIG. 6 shows the method stage in which the transfer of the confectionery items from the downwardly directed suction elements 6 of the first gripping arrangement 5 to the upwardly directed suction elements 20 of the second gripping arrangement 19 is effected. At this point in time the suction effect for the suction elements 6 of the first gripping arrangement is switched off and the suction effect for the suction elements 20 of the second gripping arrangement 19 is switched on.

The second gripping arrangement 19 is furthermore provided with an axis of rotation 21, about which the second gripping arrangement 19 can be rotated. The axis of rotation 21 has a rotary drive (not represented). For the second gripping arrangement, two functional rotational positions are defined, namely a receiving position, as shown in FIG. 5, with upwardly directed suction elements 20 as well as a depositing position rotated 180° about the axis of rotation 21, in which the suction elements 20 are directed downwards. The receiving position of the second gripping arrangement 19 coincides with the intermediate position of the first gripping arrangement 5.

The axis of rotation 21 of the second gripping arrangement is arranged such that on the one hand the confectionery items 2 are turned over by means of a rotation from the receiving position into the depositing position, from their upside down position to the upright position, which they are to adopt in the depositing position. At the same time, the confectionery items 2 are transported over the required distance per rotational movement from the receiving position to the depositing position.

FIG. 7 represents the method step with which the transfer device 18 transfers the confectionery items 2 into the depositing position by means of the second gripping arrangement 20. According to FIGS. 5 to 7, a depositing plate 22 is provided for the depositing position. In the method stage of FIG. 7, the suction effect of the suction elements 20 is switched off, with the result that the confectionery items 2 then stand on the depositing plate 22. The second gripping arrangement 19 can then be rotated 180° about the axis of rotation 21 again back into the receiving position, in order to repeat the method steps.

FIG. 8 shows an enlarged representation of the section marked with VIII in FIG. 1. The section VIII contains a suction element 6. According to FIG. 8, the suction element 6 has a bellows 23, which preferably consist of silicone or rubber. In the present example, the bellows 23 are provided with a round cross section. The suction element has a suction rim 24 opening in a funnel shape. This design has proved to be expedient in order to be able to hold confectionery items sufficiently firmly when a confectionery item adheres firmly in the cavity of a casting mold and the casting mold is set in vibration in order to release this force of adhesion.

Moreover, the suction element 6 with the bellows 23 is also well suited to being able to grip uneven surfaces in a sucking manner. In the present case, the second gripping arrangement must be able to grip the top of the confectionery items 2. Compared with the flat bottom of the confectionery item, the top of the confectionery items is rather uneven and more difficult for a suction element to grip.

The suction element has a connection end 25 with a fastening thread 26, as well as with a central channel 27 for connecting the suction element 6 to the vacuum mechanism 10 via a vacuum line (not represented).

Apart from the above-described nature of the suction element, each suction element 6 can furthermore be connected to a common air chamber 29 in the gripping arrangement 5 via a flow resistance with a small hole (not represented). In this way, it is possible to apply a partial vacuum to all suction elements 6 together.

It can happen that no confectionery item is present for one of the suction elements 6, as a result of which outside air is sucked in by this suction element 6. Due to the built-in flow resistance, the volumetric flow of the sucked-in outside air is minimized. The device can therefore also be operated when a confectionery item is not present for all suction elements 6, as long as a sufficient partial vacuum still remains in order to hold the confectionery items present sufficiently firmly for the purpose of demolding from a casting mold.

With reference to FIG. 9, a demolding of a confectionery item 2 from a cavity 4 of a casting mold 3 is represented in four method steps a)-d). In the first method step a), the confectionery item 2 is located upside down in the cavity 4, wherein a boundary layer 30 of the confectionery item 2 adheres without a gap to a contact surface 31 of the cavity 4. In this first method step a), a suction element 6 is moved towards a bottom 32 of the confectionery item 2.

In the second method step b), the suction element 6 has sucked the bottom 32 of the confectionery item 2 in and holds it firmly. The bottom 32 has bulged slightly in a dome shape and protrudes to a certain extent into the suction element 6. At the base of the cavity 4 the confectionery item 2 has partially detached from the contact surface 31 and a hollow space 33 has thereby formed. A negative pressure has formed in the hollow space 33. The negative pressure holds the confectionery item 2 firmly in the cavity 4 in a sucking manner.

In a third method step c), the bottom 32 of the confectionery item 2 continues to be held firmly, as in the preceding method step a), and a detachment movement 34 in the form of a vibration of the casting mold 3 additionally takes place. Due to the detachment movement 34, the force of adhesion of the confectionery item 2 in the cavity 4 is reduced in such a way that it can be demolded from the cavity 4 in a subsequent fourth method step by being moved out of the cavity 4.

In the representation of the fourth method step d), the confectionery item 2 is completely detached from the contact surface 31 of the cavity 4 all around and has already moved out of the cavity 4 by a small amount. The further complete demolding of the confectionery item 2 then succeeds without problems.

### LIST OF REFERENCE NUMBERS

1 device for demolding
2 confectionery item
3 casting mold
4 cavity
5 gripping arrangement
6 suction element
7 movement mechanism
8 lifting unit
8A carrying element
8B guide unit (vertical)
9 sideways unit
9A linear guide (horizontal)
9B carriage element
10 vacuum mechanism
11 means for detachment movement
12 casting mold receiver
13 swing bearing
14 vibration generator
15 bar element
16 depositing element
17 receiving element
18 transfer device
19 second gripping arrangement
20 suction element
21 axis of rotation
22 depositing plate
23 bellows
24 suction rim
25 connection end
26 fastening thread
27 central channel
29 air chamber
30 boundary layer
31 contact surface
32 bottom
33 hollow space
34 detachment movement

1. A method for demolding at least one confectionery item (2), which is to be demolded upside down from a cavity (4) of a casting mold (3) by means of a gripping arrangement (5), wherein the gripping arrangement (5) comprises at least one suction element (6), with which the upwardly standing, substantially flat bottom (32) of the confectionery item (2) is sucked in, wherein the confectionery item (2), where it is transferred upside down by switching off the negative pressure, wherein, before or after the suction element (6) has sucked the bottom (32) of the confectionery item (2) in, a detachment movement is generated which introduces alternating forces into the confectionery item (2), which generate deformations in the confectionery item (2), which act up to its outer boundary layer and reduce its force of adhesion to the contact surface of the cavity (4) and at least partially release the force of adhesion, and in that the confectionery item (2) is then taken completely out of the cavity (4) by the suction element (6).

2. The method according to claim 1, wherein, for the detachment movement, the suction element (6) sucks the bottom (32) of the confectionery item (2) in and holds it firmly and a relative movement between the suction element (6) and the casting mold (3) is generated, with the result that the force of adhesion of the outer boundary layer of the confectionery item (2) is at least partially reduced on the contact surface of the cavity (4) by means of the relative movement.

3. The method according to claim 1, wherein the detachment movement is provided as an oscillating detachment movement or a circling detachment movement, and in that the detachment movement is performed by the casting mold (3) and/or the suction element (6).

4. The method according to claim 1, wherein the detachment movement is performed in the plane of the casting mold (3).

5. The method according to claim 1, wherein the detachment movement is performed exclusively or additionally with a movement component in a direction orthogonal to the plane of the casting mold (3).

6. A method for transferring at least one confectionery item (2) from a casting mold (3) towards a depositing position, wherein the confectionery item (2) is demolded upside down from a cavity (4) of the casting mold (3) and then turned to an upright position, with the result that it is transferred to the depositing position in the upright position, wherein a first gripping arrangement (5) takes the confectionery item (2) out of the cavity (4) upside down by means of a downwardly directed suction element (6) and transfers it to a second gripping arrangement (20) in an intermediate position in the upside down position, wherein the second gripping arrangement (20) has a rotatably arranged suction element (21), which accepts the confectionery item (2) in the upside down position, and wherein the second gripping arrangement (20) then turns the confectionery item (2) to the upright position and transfers it to the depositing position, wherein the confectionery item (2) is demolded from the cavity (4) of the casting mold (3) according to the method of claim 1 and taken out of the cavity (4).

7. A device (1) for demolding at least one confectionery item (2) from a cavity (4) of a casting mold (3), the device comprising:
a gripping arrangement (5) with at least one suction element (6); and
a means (11) for performing a detachment movement is provided for a confectionery item (2), the outer boundary layer of which adheres in a sticking manner in the cavity (4) of the casting mold (3), in that alternating forces can be introduced into the confectionery item (2) via the means (11) for performing the detachment movement, whereby deformations can be generated on a boundary layer of the confectionary item (2), with the result that the force of adhesion of the confectionery item (2) in the cavity (4) can be released to such an extent that the coupling suction forces of the suction element (6) are sufficient in order to take the confectionery item (2) out of the cavity (4) by means of the suction element (6).

8. The device according to claim 7, wherein the casting mold (3) is a hard, dimensionally stable casting mold (3) made of a metal or made of a solid plastic.

9. The device according to claim 7, wherein the means (11) for performing the detachment movement is set up for generating an oscillating or circling detachment movement.

10. The device according to claim 7, further comprising a movement unit (7) for the gripping arrangement (5) is provided, and in that the gripping arrangement (5) is movable by means of the movement unit (7) at least in two movement directions.

11. The device according to claim 7, wherein the gripping arrangement (5) has an air chamber (29), at least two suction elements (6, 21) connected to the air chamber (29) are provided, and each suction element (6, 21) is provided with a flow resistance.

12. A device (19) for transferring at least one confectionery item (2) from a starting position, in which the confectionery item (2) adheres in a cavity (4) of a casting mold (3) and can be demolded from the casting mold, towards a depositing position, as the device comprising:
a first gripping arrangement (5) with at least one downwardly directed suction element (6) and a movement unit (7) for moving the confectionery item (2) from the starting position towards an intermediate position,
a second gripping arrangement (20) is provided which has an axis of rotation (22) and at least one suction element (21), which is arranged movable about the axis of rotation (22),
at least two functional rotational positions are defined for the second gripping arrangement (20), a receiving position with upwardly directed suction element and a depositing position with downwardly directed suction element (21), and
the device (1) according to claim 7 is for demolding the confectionery item (2) from the cavity (4) of the casting mold (3).

13. The device according to claim 12, wherein the intermediate position of the first gripping arrangement (5) coincides with the receiving position of the second gripping arrangement (20).

14. The device according to claim 13, wherein the axis of rotation (22) of the second gripping arrangement (20) is arranged such that, by a rotation from the receiving position into the depositing position, the confectionery item (2) is turned from the upside down position to the upright position and at the same time can be transported from the receiving position to the depositing position.

15. The device according to claim 10, wherein the two movement directions include translationally in a sideways direction back and forth and a vertical direction up and down.
